(19) United States
(12) Patent Application Publication
(10) Pub. No.: US 2008/0224493 A1
(43) Pub. Date: Sep. 18, 2008

(54) STORAGE AND ACCESS DEVICE FOR A TRUCK

(76) Inventor: Stephen Ferris, Marlborough, MA (US)

Correspondence Address: LAW OFFICE OF BRETT N. DORNY, 386 WEST MAIN STREET, SUITE 12A, NORTHBOROUGH, MA, 01532, US

(21) Appl. No.: 11/685,366

(22) Filed: Mar. 13, 2007

(51) Int. Cl. B60R 9/00

(52) U.S. Cl. 296/37.6

(57) ABSTRACT

A container is disclosed for a pickup truck. The container is formed as a box positioned upon the sides of the pickup truck. The sides of the container open upward to allow easy access to the interior of the compartment. Trays may be positioned within the container which can be extended for access to items within the container. Equipment may be attached to the trays and used along the side of the container and pickup truck when the tray is extended. According to another embodiment, the sides of the pickup truck are formed as doors which open upward.

### BACKGROUND OF THE INVENTION

1. Field of the Invention

The present invention relates to trucks. More particularly, it relates to structures for easy storage and access with the bed of a pickup or flatbed truck.

2. Discussion of Related Art

Pickup trucks are very popular. They are used for both work and pleasure. While they can be used to carry lots of things, accessing items in the bed of the pickup truck can be very difficult. Also, they typically do not include enclosed spaces which protect items from the elements. For many workers, tools and equipment need to be transported. An enclosed space which is easily accessed would be useful.

Various bins, lockers and containers have been developed for use in pickup trucks to provide an enclosed space for storing items. Typically, such devices are placed or attached to the bed of the pickup truck near the cab. The top is hinged so that it can be opened to access the storage compartment. In order to access the contents, the user has to climb into the bed of the truck. A portion of the bed of the truck occupied by the storage compartment is not useable for carrying other items. Therefore, a need exists for a storage compartment which is easily accessed from the side of the pickup truck and which allows full use of the truck bed.

For special uses, trucks can be customized with specific sides or containers built into the truck. For example, a lunch truck has a multi compartment container built onto the truck. It opens from the side for the server to access the stored food for sale. Other trucks have sides which are custom built with separate enclosed compartments. Such specialized trucks are expensive and cannot be changed nor modified without great expense.

### SUMMARY OF THE INVENTION

The present invention overcomes many of the deficiencies of existing storage containers for pickup trucks through use of a side opening structure mountable above the sides of the pickup truck. According to one aspect of the invention, a storage container is formed of a size to fit across the sides of the pickup truck. The container is supported by the sides and leaves the bed open. According to another aspect of the invention, the container is accessible through doors on the sides of the container. According to another aspect of the invention, the doors are hinged along the top so that they open upwards. According to another aspect of the invention, the container is easily attached to and removed from the pickup truck. According to another aspect of the invention, sliding trays are positioned within the container. Equipment is mounted to the sliding trays. The equipment can be used when the container and the tray are in a opened position.

According to another aspect of the invention, a storage container is sized to fit on a flat bed truck. According to another aspect of the invention, the container is accessible through doors on the sides of the container. According to another aspect of the invention, the doors are hinged along the top so that they open upwards. According to another aspect of the invention, a set of legs are attached to the container. The legs are adjustable to lift the container from the truck bed. The legs are used to support the container at a work site.

According to another aspect of the invention, a pickup truck is constructed for easy access to the bed. The sides of the pickup truck are hinged to create doors. According to another aspect of the invention, the side doors of the pickup truck are hinged along a top edge. A latch is positioned along a bottom edge to permit the side doors to be opened upwardly.

### BRIEF DESCRIPTION OF THE DRAWINGS

FIG. 1 is a partial side view of a pickup truck having a container according to an embodiment of the present invention.

FIG. 2 is an end view of the pickup truck of FIG. 1.

FIG. 3 is a cross sectional view of a container according to an embodiment of the present invention.

FIG. 4 is another cross sectional view of a container according to an embodiment of the present invention.

FIG. 5 is a side view of a flat bed truck with a container according to a second embodiment of the present invention.

FIG. 6 is an end view of the truck and container of FIG. 5.

FIG. 7 is a perspective view of a container according to a third embodiment of the present invention.

FIG. 8 is a perspective view of a drawer for use in a container according to an embodiment of the present invention.

FIG. 9 is a partial perspective view of pickup truck according to another embodiment of the present invention.

FIG. 10 is another partial perspective view of the pickup truck of FIG. 9 with the side door in a partially opened position.

### DETAILED DESCRIPTION

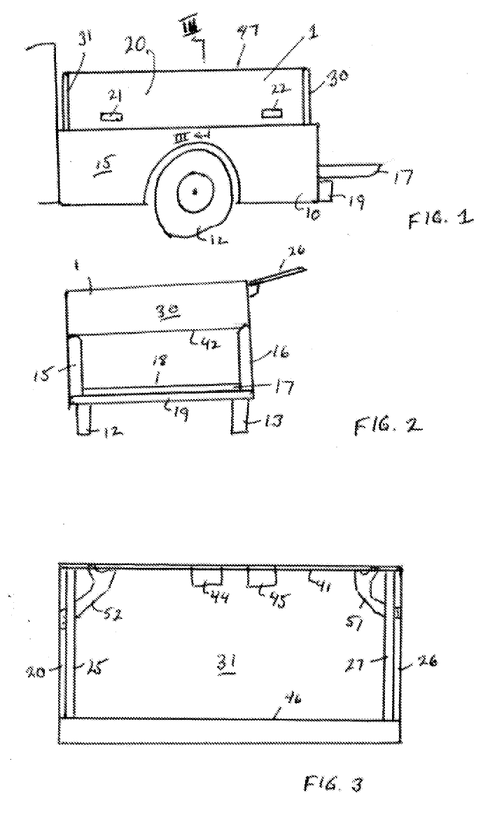

The present invention allows easy storage of and access to equipment and supplies in connection with a pickup truck. A first embodiment of the invention is illustrated in FIGS. 1-4. FIGS. 1 and 2 illustrate a pickup truck 10 including a container 1 according to the first embodiment of the invention. As is conventional, the pickup truck 10 includes sides 15, 16, a tailgate 17, and bumper 17 surrounding the bed 18 of the truck. As illustrated in FIGS. 1 and 2, a container 1 of the present invention is sized to fit between the sides 15, 16 of the pickup truck 10 so that the container 1 is positioned above and separated from the bed 18. Since the container 1 is separated from the bed 18, items can be placed on the entire length of the bed. The container 1 is in the form of a box having two ends 30, 31, a top 47, a bottom 42 and two sides 20, 26. The two sides 20, 26 are formed to function as doors to access the interior of the compartment. According to an embodiment of the invention, the sides 20, 26 are hinged at the top 47. A pair of handles 21, 22 are located in each side 20, 26 to open the door. Side 26 is shown in the open position in FIG. 2. The sides 20, 26 sit above the sides 15, 16 of the pickup truck 10 so that they can be easily opened. The container 1 is shown as extending along the entire length of the bed of the pickup truck 10. Of course, the container may have different lengths and may cover only a portion of the bed.

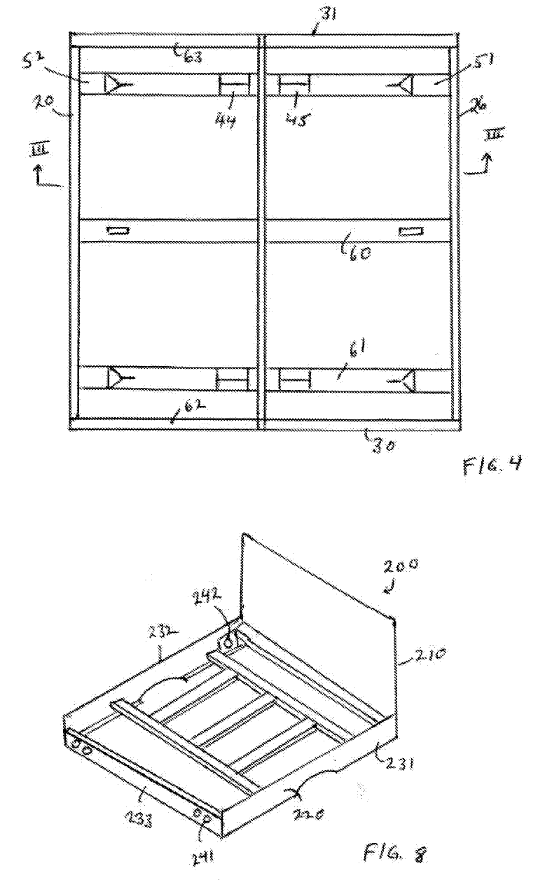

FIGS. 3 and 4 illustrate construction of the container 1. FIG. 3 illustrates a cross sectional view towards the front of the pickup truck 10. FIG. 4 illustrates a view from above with the top 47 removed. As illustrated in FIGS. 3 and 4, the container 1 may be constructed of formed metal pieces which are joined together. Sheet metal is used for the ends 30, 31, top 47, bottom 42, and sides 20, 26. Box supports are used to provide structure to the container 1. The box supports may be formed by bending sheet metal to form channels. Other known methods can be used to form the box supports. As illustrated, the container 1 may be formed with three box supports 41, 60, 61 along the top. A pair of brackets 44, 45 are connected towards the center of the box supports. The sheet metal top 47 is attached to the top side of the top three box supports 41, 60, 61. The bottom 42 is formed as a tray having a bottom, and sides. Box supports 62, 63 may be positioned along the ends of the bottom tray. The sheet metal ends 30, 31 are connected to the bottom tray and the top 47.

Additional box supports 25, 27 are attached to the sides 20, 26. Multiple box supports, positioned parallel to each other, may be connected to each side. Preferably, the same number of box supports are used for the top and the sides. The side box supports 25, 27 are connected to the top box support 41 by hinged brackets 51, 52. The hinged brackets allow the sides 20, 21 to be opened.

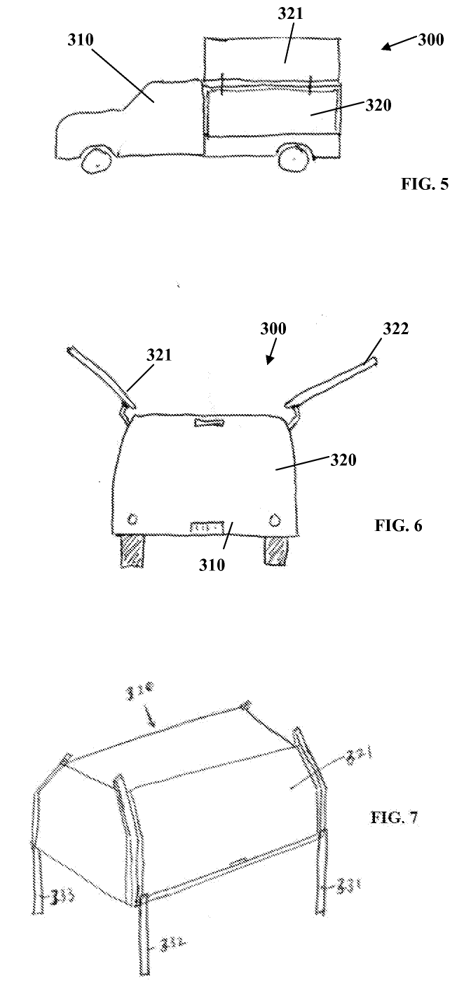

FIGS. 5 and 6 illustrate a second embodiment of the container of the present invention. In the second embodiment 300, a container 320 is sized and arranged to fit on a flat bed truck 310. As in the first embodiment, the container 320 includes two doors 321, 322 on the sides. The doors 321, 322 are hinged at the top to open upward so that the interior can be accessed from the sides. As illustrated in FIGS. 5 and 6, the container 320 is not limited to a rectangular cross section and can have various shapes. According to an embodiment of the invention, a top portion of each side of the container 320, and of each of the doors 321, 322 which form the sides, is angled inward so that the top is narrower than the bottom.

FIG. 7 illustrates a third embodiment of the container 320 of the present invention. The third embodiment includes a container 320 similar in structure to that of the second embodiment. In the third embodiment, four legs 331, 332, 333 (one is not visible) are connected to the container 320 near the corners. Preferably, the legs 331, 332, 333 are detachable or can rotate so as to not extend from the container when on the truck. Additionally, the legs 331, 332, 333 are extendible. When in the vertical position (or attached), the legs can be extended to raise the container 320 from the bed of the truck. The container 320 can be left freestanding without the truck. The container 320 can be left at a work site where the equipment can be easily accessed and used. Of course, the first embodiment of the container could also include legs for lifting the container off of the pickup truck.

According to an embodiment of the invention, trays are positioned within the container 1, 320 to permit easy access to equipment within the container 1, 320. Additionally, equipment may be attached to the trays to hold it in position for use. An embodiment of a tray 200 is illustrated in FIG. 8. The tray 200 has a base 200 and a front panel 210. The base includes three sides 231, 232, 233. The sides are held together by a support structure 221. The front panel 210 is attached to two of the sides 231, 232 of the base 220. Various openings 241, 242 may be formed in the sides to accommodate different types of equipment. If power is equipment is used, electrical cord may pass through the openings to a generator or other power source. The trays 200 can be placed on the bottom 42 of the container 1, 320. Preferably, tracks would connect the trays 200 to the bottom 42 of the container so that they are held into place when extended.

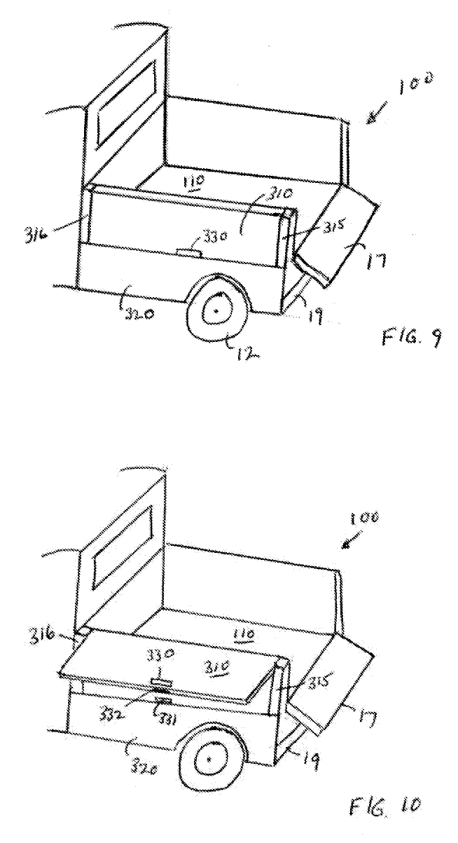

FIGS. 9 and 10 illustrate another embodiment of the invention which permits easy access to the bed 110 of a pickup truck 100. While the tailgate 17 of the pickup truck 100 can be opened, items located near the cab are not easily reached from the rear. According to the present invention, one or more sides of the pickup truck are hinged at the top, similar to the container 1 of the first embodiment, such that they can be opened to access the bed 110 of the pickup truck 100 from the side. The side of the pickup truck 100 is formed in several parts. A bottom part 320 near the wheel 12 is of ordinary construction as a body panel. The bottom part 320 connects at its top edge 321 to the bed 110 of the pickup truck to form an corner. Above the bottom part 320 are three parts. A door 310 is positioned between two supports 315, 326. The supports 315, 316 are positioned at the front and rear corners of the bed 110. The supports 315, 316 are connected to the structure of the truck. The door 310 is hingedly connected to the supports at the top corners. Different types of hinges may be used to the door 310. According to one embodiment, a rotational hinge is positioned within the door 310 and supports. 315, 316. Preferably, the hinges allow the door 310 to be held in an open position. A handle 330 is positioned in the door 310. Of course, multiple handles may be used. In an ordinary manner, the handle 330 is connected to a latch 332 in the door 310. The latch 332 has a corresponding connector 331 in the bed 110 to hold the door closed. FIGS. 9 and 10 illustrate a door in one side of the pickup truck 100. Alternatively, both sides of the pickup truck may include a door.

Having disclosed at least one embodiment of the present invention, various adaptations, modifications, additions, and improvements will be readily apparent to those of ordinary skill in the art. Such adaptations, modifications, additions and improvements are considered part of the invention which is only limited by the several claims attached hereto.

1. A storage container for a truck comprising:
a box having a top panel, a bottom panel spaced apart from the top panel, front end panel along one edge of the top panel and one edge of the bottom panel, and back end spaced apart from the front end panel, the box being sized to fit on the truck; and
at least one hinged side positioned at an outside edge of the box.

2. The storage container for a truck according to claim 1 wherein the at least one hinged side includes a hinge along a top edge.

3. The storage container for a truck according to claim 1 further comprising a support which holds the bottom panel of the box spaced away from the ground.

4. The storage container for a truck according to claim 3 wherein the support is adjustable so that the distance between the bottom panel of the box and the ground can be changed.

5. The storage container for a truck according to claim 3 wherein the support extends past the sides of the truck when the box is positioned on the truck such that the box can be raised.

6. The storage container for a truck according to claim 3 wherein the support includes four legs.

7. The storage container for a truck according to claim 1 wherein the sides are substantially planar.

8. The storage container for a truck according to claim 1 wherein the at least one side has at least one angular bend along a line between the top panel and bottom panel.

9. The storage container for a truck according to claim 1 further comprising at least one tray positioned within the box.

10. The storage container for a truck according to claim 9 wherein the at least one tray is attached to the bottom panel such that it is slidably extendable from the box when the at least one side is open.

11. The storage container for a truck according to claim 1 wherein the truck is a pickup truck and wherein the box is sized to rest upon the sides of the pickup truck so that the bottom panel is spaced away from a bed of the pickup truck.

12. The storage container for a truck according to claim 1 wherein the truck is a flat bed truck and the bottom panel sits on a bed of the flat bed truck.

13. A truck bed comprising:
a bed positioned above rear wheels of the truck;
a first side support positioned along a first side of the bed including two end supports and a top support; and
a first side hingedly connected to the top support of the first side support.

14. The truck bed according to claim 13 further comprising
a first side support positioned along a second side of the bed parallel the first side including two end supports and a top support; and
a second side hingedly connected to the top support of the second side support.

15. A truck bed according to claim 13 further comprising a latch mechanism having a first part positioned in the first side and a second part positioned in one of the bed and the first support, the first part and second part of the latch mechanism operating to releasably hold the first side in a closed position.

16. A truck bed according to claim 14 further comprising a second latch mechanism having a first part positioned in the second side and a second part positioned in one of the bed and the second support, the first part and second part of the second latch mechanism operating to releasably hold the second side in a closed position.
